(19) United States
(12) Patent Application Publication
(10) Pub. No.: US 2025/0209784 A1
(43) Pub. Date: Jun. 26, 2025

(54) LEVERAGING SYNTHETIC IMAGES TO IMPROVE VISUAL LOCALIZATION IN CASE OF EXTREME DOMAIN SHIFTS

(71) Applicant: NAVER CORPORATION, Gyeonggi-do (KR)

(72) Inventors: Ioannis Kalantidis, Barcelona (ES); Rafael Sampaio de Rezende, Grenoble (FR); Mert Bulent Sariyildiz, Grenoble (FR); Philippe Weinzaepfel, Montbonnot-Saint-Martin (FR); Gabriela Csurka, Meylan (FR); Diane Larlus, La Tronche (FR)

(73) Assignee: NAVER CORPORATION, Gyeonggi-do (KR)

(21) Appl. No.: 18/805,247

(22) Filed: Aug. 14, 2024

Related U.S. Application Data
(60) Provisional application No. 63/614,113, filed on Dec. 22, 2023.

(51) Int. Cl. G06V 10/74; G06T 7/60; G06T 7/70; G06T 11/00; G06V 10/25

(52) U.S. Cl. CPC G06V 10/761; G06T 7/60; G06T 7/70; G06T 11/00; G06V 10/25

(57) ABSTRACT

The system and method to improve image retrieval models in case of extreme domain shifts for long term visual localization. An initial dataset of real images of an environment can be obtained from an image database that may comprise of matching pairs and sets of non-matching images. The initial dataset is augmented with synthetic variants of each image to represent the potential changing conditions of the environment. The synthetic variants may be generated by using generative AI models. To validate synthetic images, a geometric consistency score is calculated for each synthetic pair based on a degree of geometric correspondence between images of the synthetic pair. A subset of k synthetic tuples is selected from a set of tuples corresponding to a matching pair, either randomly or based on the geometric consistency score, to compute a contrastive loss function for training of image retrieval model along with other custom/disclosed settings.

### CROSS-REFERENCE TO RELATED APPLICATIONS

This application claims the priority to and the benefit of U.S. Provisional Patent Application No. 63/614,113, filed on Dec. 22, 2023, which is hereby incorporated by reference in its entirety for all purposes.

### BACKGROUND

Autonomous mobile robots are making positive contributions by providing smart and autonomous services in the fields of manufacturing, healthcare, and logistic systems. The smart robots can improve the efficiency and effectiveness of the systems by performing tasks autonomously, such as handling materials, doing surveillance of the ambient environment, and conducting complex surgeries with higher accuracy and precision. In other roles, they may serve as assistants for people to do tasks, such as cleaning, washing, cooking, and security of a home or office building. They can also deliver packages and lunch boxes to people in an office building. These robots can be designed to operate autonomously, navigating through complex indoor or outdoor environments without significant human intervention.

The robots can utilize indoor or outdoor localization techniques for ensuring accurate navigation in the environment. The outdoor localization can use the GPS technology, which is effective in open spaces only and might pose significant challenges in urban canyons and environments with a limited satellite visibility. Indoor localization utilizes methods like Wi-Fi fingerprinting, infrared sensors, beacons, tags, inertial measurement units, and cameras to determine a robot's position within a building. The one way to localize the position of a robot accurately in both types of environments might be to use the perception system of a robot that that does not rely on specific external sensors such as beacons, tags, or RFID. One such method is visual localization, that can estimate the pose of a robot from its camera by analyzing the image of the scene he is currently viewing using its visual localization pipeline.

The robots can utilize indoor or outdoor localization techniques for ensuring accurate navigation in the environment. The outdoor localization can use the GPS technology, which is effective in open spaces only and might pose significant challenges in urban canyons and environments with a limited satellite visibility. Indoor localization utilizes methods like Wi-Fi fingerprinting, infrared sensors, beacons, tags, inertial measurement units, and cameras to determine a robot's position within a building. The one way to localize the position of a robot accurately in both types of environments might be to use the perception system of a robot that that does not rely on specific external sensors such as beacons, tags, or RFID. One such method is visual localization, that can estimate the pose of a robot from its camera by analyzing the image of the scene he is currently viewing using its visual localization pipeline. The visual localization pipeline may start with an image retrieval step. This step can provide a first coarse grain localization estimate based on the information of the camera pose, extracted from similar images of the scene or location, and are retrieved from an image database that contains images of the environment in which the robot is operating. The image retrieval component of visual localization pipeline can be sensitive to the changes of the environment as observed by the robot. Sometimes the changes in appearance of a visual scene due to different poses cannot be recognized from the pure visual information. The challenges in the visual localization may include changes in lighting conditions, occlusions, day-night changes, as well as weather and seasonal variations. Therefore, it is important to make image retrieval models robust against these changes in appearances of images to do accurate localization prediction. Providing solutions to these challenges will improve the reliability and accuracy of autonomous mobile robots in real-world environments with changing ambient conditions.

### SUMMARY

Some embodiments of the present disclosure relate to use of generative AI models to generate synthetic images for augmenting training dataset, validate synthetic images using geometric filters, and to improve training process of image retrieval model that is aiming for accurate long term visual localization. A computer-implemented method includes accessing an initial dataset of real images of an environment from an image database. The initial dataset may have at least one matching image and a set of non-matching images for each image of the initial dataset. The matching image represents a similar scene of the environment as contained in the image of the initial dataset.

The method further includes identifying a set of matching pairs in the initial dataset. A matching pair comprises of images that can capture similar aspects or scenes of the environment. For each matching pair in the initial dataset, a set of tentative pairs is generated. Each tentative pair includes at least one synthetic image. The tentative pairs may be generated by making image pairs, either combining a first image of the matching pair with the synthetic images of a second image of the matching pair, or the synthetic images of the first image of the matching pair with the second image of the matching pair.

The method further includes identifying a set of domain shifts that corresponds to potential changes in the same environment as of the image database. A text prompt may be generated for each of the identified domain shifts. The set of domain shifts may include indoor and/or outdoor changing conditions of the environment. The outdoor changing conditions may correspond to weather, season, or time of day related information that may also be reflected in the scenes of the environment. The indoor changing conditions may include holiday or event related changes such as Christmas, Kwanzaa, Hanukkah, Easter, Sales events and similar public or religious holidays that may add, remove, or dislocate objects thereby changing the indoor scenes within the environment. A synthetic image may be generated for each image of the initial dataset and for each of the set of domain shifts, by processing the text prompt with the generative AI model. In some instances, the synthetic images may be generated by simulating each of the set of domain shifts using a 3D game engine.

To determine whether the tentative pair is a valid pair or not, geometric correspondences can be computed between images of the tentative pair inside an area of interest. The tentative pair may be considered as a valid pair or valid synthetic pair based on the degree of the geometric correspondence. In some instances, a geometric transformation can be computed between the first image and the second image of a matching pair of the initial dataset. The method may further compute, for each of the tentative pairs corresponding to the matching pair, a number of local geometric correspondences that satisfy the geometric transformation. The tentative pair corresponding to the matching pair may be considered valid if an absolute or relative number of local geometric correspondences inside the area of interest of two images exceeds a threshold.

The valid pairs can be combined with the initial dataset to generate an extended dataset. A contrastive loss function can be used to train an image retrieval model with weights assigned to each matching pair and corresponding valid pairs in the extended dataset. The weights can be proportional to the degree of geometric correspondence inside the area of interest between images of the matching pair or the valid pair. To improve training of the image retrieval model, domain randomization may be applied to improve resilience to domain shifts. For domain randomization, a random cropping mechanism may be used at first and then a data augmentation technique that mixes multiple augmentations such as AugMix. The image retrieval model may be trained using an optimizer such as AdamW optimizer for a longer time with a cosine learning rate schedule. The trained image retrieval model can be used to retrieve a set of matching images from the image database by processing a query image that is captured by a camera device to localize a position and/or orientation of the camera device.

The area of interest can be determined by computing a matching function which returns a set of matches that are geometrically consistent between two images of the matching pair. The matching function can be any function which takes two images as input and provides a set of correspondences as an output. For example, if the task is in 3D, then the matching function may perform matching over 3D models. The area of interest is composed of image pixels corresponding to the set of matches. In some embodiments, the area of interest is determined based on identical sets of 3D co-observations between two images of the matching pair. In this case, the area of interest is composed of image pixels corresponding to matching 3D co-observations of the two images.

In some embodiments of the present disclosure, a first set of correspondences can be determined between images of the matching pair using a matching function. Similarly, a second set of correspondences can also be determined between images of the tentative pair corresponding to the matching pair using the matching function. Moreover, common geometric correspondences may be identified between the first set of correspondences and the second set of correspondences. A geometric consistency score can be computed for the tentative pair by taking a ratio of the common geometric correspondences with the first set of correspondences in the matching pair.

The method can further include generating a set of synthetic tuples based on the set of tentative pairs corresponding to the matching pair. Each tuple of the set of synthetic tuples may comprise of images of the tentative pair and the set of non-matching images with the tentative pair. A subset of k tuples may be selected from the set of synthetic tuples for training the image retrieval model. In some instances, the subset of k tuples is selected randomly, whereas in other instances the subset of k tuples is selected based on the geometric consistency score. The synthetic tuple with a lower geometric consistency score has a higher probability of selection. The contrastive loss function may be computed on the subset of k tuples to update model parameters.

The technique disclosed in the present disclosure can be utilized for any AI task that can have following properties: 1) model training is performed on image pairs, 2) the domain shifts are known and can be synthesized by generative AI models, and 3) geometric consistency is important for the task.

In some embodiments, a system is provided that includes one or more data processors and a non-transitory computer readable storage medium containing instructions which, when executed on one or more data processors, cause one or more data processors to perform part or all of one or more methods disclosed herein.

In some embodiments, a computer-program product tangibly embodied in a non-transitory machine-readable storage medium, including instructions configured to cause one or more data processors to perform part or all of one or more methods or processes disclosed herein.

In some embodiments, a system is provided that includes one or more means to perform part or all of one or more methods or processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The present disclosure is described in conjunction with the appended figures.

FIG. 1 shows an example network for performing a method of visual localization to determine a pose of an autonomous mobile robot in accordance with an example implementation of the present disclosure.

FIG. 2 shows an example block diagram to generate synthetic images for an extended dataset in accordance with some embodiments of the present disclosure.

FIG. 3 illustrates another exemplary block diagram of synthetic images generation for the extended dataset in accordance with an example implementation of the present disclosure.

FIG. 4 illustrates an example implementation of a pair validator to identify valid synthetic pairs in accordance with an embodiment of the present disclosure.

FIG. 5 shows exemplary components of a visual localization pipeline that can be implemented using the example network of FIG. 1, in accordance with an example implementation of the present disclosure.

FIG. 6 illustrates exemplary components of an image retriever of the example visual localization pipeline of FIG. 5, in accordance with an example implementation of the present disclosure.

FIG. 7 shows an example implementation of an encoder used in the image retriever, in accordance with the example implementation of FIG. 6.

FIG. 8 illustrates an exemplary training method of the example encoder of FIG. 6 using the extended dataset in accordance with an example implementation of the present disclosure.

FIG. 9A shows an illustrative example of geometric correspondences between a matching pair (at the top) and its good synthetic variants (bottom three) which preserved a certain fraction of geometric correspondences.

FIG. 9B shows an illustrative example of geometric correspondences between the matching pair (at the top) and its bad synthetic variants (bottom three) which did not preserve the certain fraction of geometric correspondences.

FIG. 10 shows an example illustration of 11 synthetic variants of an original image (top left) from RobotCar Seasons Dataset.

FIG. 11A shows an illustrative example of region of interest for the matching pair using 3D co-observations.

FIG. 11B shows an illustrative example of region of interest for the matching pair using Deep Matching.

FIG. 12 schematically illustrates an example architecture of a computing system that can implement at least one example of disclosed visual localization method.

FIG. 13 illustrates an example flow of a computer implemented method for enhanced image retrieving according to an example embodiment.

FIG. 14 shows localization accuracy results as a function of top-k retrieved images for Ret4Loc models and state of the art in accordance with an example implementation of the present disclosure.

FIG. 15 shows a percentage of synthetic pairs dropped for different thresholds tau on geometric consistency score in accordance with an example implementation of the present disclosure.

FIG. 16 shows the percentage of synthetic pairs dropped per text prompt for t=0.5 in accordance with an example implementation of the present disclosure.

FIG. 17 shows relative localization accuracy gains on Robotcar-v2 dataset for different tau values for Ret4Loc-HOW-Synth+ (solid lines) and Ret4Loc-HOW-Synth++ (dashed lines) for localization across three error thresholds, in accordance with an example implementation of the present disclosure.

FIG. 18 shows analysis results of alignment loss versus uniformity loss using pre-extracted features from a validation set of SfM-120K, in accordance with an example implementation of the present disclosure.

### DETAILED DESCRIPTION

The present disclosure discloses embodiments relating to an enhanced image retrieval component for long-term visual localization in case of extreme domain shifts. In some embodiments, techniques are provided to utilize generative AI models to generate synthetic images for augmenting training dataset, validate synthetic images using geometric filters, and to improve training process of image retrieval model that is aiming for accurate long term visual localization.

Visual localization refers to the task of estimating the camera pose for a given view of a known scene and is a core component of a perception system of autonomous vehicles and robotic platforms. For example, given a view of the known scene that is currently observed by a robot, often a 2D image captured by a camera, the visual localization task is to provide an accurate estimate of six degree-of-freedom camera pose to compute the robot's position by using visual data only. The visual localization pipeline may comprise of an image retrieval component and a pose estimator. The quality of the retrieval component is affected by the appearance of landmarks that are altered depending on the changing conditions such as weather, season, occlusions, or time of day. The visual localization under such varying environmental conditions is referred to as long-term visual localization with changing conditions or long-term visual localization with extreme domain shifts.

The image retrieval component is responsible for retrieving images based on the similarity with the given view (also refer herein as a query image) from an image database containing images of the environment in which the robot is planned to operate. In some of the embodiments, the image retrieval component may include a feature extractor and a feature comparator. The feature extractor may be comprising of handcrafted local descriptors, bag-of-words representations, or more sophisticated aggregation techniques such as Fisher Vectors or Aggregated Selective Match Kernels (ASMK). Moreover, deep learning-based models such as

Convolutional Neural Network (CNN) encoders can also be used to generate global descriptor per image for the retrieval task. In this case, feature vectors can be generated either directly or by aggregating local activations of the deep model. In some instances, the feature comparator may include ASMK to evaluate the similarities between the feature vectors of the query image and the retrieved images. The ASMK is a matching process defined over selective matching kernel of local features and it is a relatively more precise matching function than the global representations.

The pose estimator then estimates the pose for the query image by using the camera pose information assigned to the retrieved images. In some instances, only top k retrieved images may be used to predict the camera pose. The pose can be predicted either by interpolating or approximating the poses from the top k retrieved images, or by using a complex method for increased precision. The complex method may include utilization of the local or global 3D maps created via Structure from Motion (SfM) such as COLMAP and the query image pose can be estimated by registering it in the 3D map.

To enhance the performance of retrieval component, some embodiments of the present invention include using text-to-image generation techniques to alter images from an initial dataset and expand the initial dataset with a set of synthetic variants. The synthetic variants can be generated for some or all the images in the initial dataset for several meaningful domain shifts that can be described with words. The synthetic variants can be generated by using the generative AI models such as DALL-E or Stable Diffusion to synthesize different challenging scenarios of the environment. In addition, images of the initial dataset can be altered via a textual prompt by using methods like InstructPix2Pix, ControlNet, or EmuEdit. In some instances, the synthetic images or variants may be generated by simulating different domain shifts using a 3D game engine. The synthetic variants together with the initial dataset may be used to train generic representations that can transfer across a broad range of the classification tasks.

Text prompts can be selected to describe meaningful domain shifts. For example, prompts for indoor localization may include alterations due to holiday or event related changes such as Christmas, Kwanzaa, Hanukkah, Easter, Sales events, and the like. For outdoor scenarios, the text prompts may capture the changing conditions related to weather, seasons, or time of the day. Moreover, the generation of synthetic images may happen on-the-fly during batch construction for training of a model or can be implemented as a preprocessing step.

In some aspects of the present disclosure, a subset of synthetic images may be selected by using geometric filtering to achieve better training of the image retrieval model. Some of the generated synthetic images may not be suitable for learning representations of visual localization. The characteristics of the scene may get altered during the generation process. Moreover, while the synthetic image generation step deals with each image of the initial dataset individually, the training process of the image retrieval model focuses on image pairs. Therefore, geometric filtering can be used to automatically verify the validity of an image pair.

For example, a training dataset D of images may be considered suitable for landmark retrieval. The matching pairs can be found in the training dataset D. The term ‘matching pair’ as used herein refers to the images depicting the same scene or landmark. The training dataset D can be seen as a set of training tuples of matching pairs (q, p) composed of a query and a positive image, together with a small set of M negatives U_{qp}={q, p, n₁ . . . , nₘ}. The set of M negatives comprises of images that capture a different scene or landmark. For the matching pair (q, p), the ( [symbol] , p) may represent a corresponding synthetic pair where the query is replaced by a synthetic variant obtained with a text prompt t. As used herein, the terms “synthetic pair” and “tentative pair” are used interchangeably. Consider a matching function C_{qp}=c(·,·) that returns a set of correspondences Cap i.e., a set of geometrically consistent local matches between q and p. For the synthetic pair ( [symbol] , p), the geometric correspondences Caty may be computed by using the matching function and only those correspondences that also existed in the original pair (q, p) are kept: ∥C_{q}_{^{−t}}ₚ∥′=∥C_{q}_{^{−t}}ₚ∥∩∥C_{qp}∥. Afterwards a geometric consistency score can be computed by taking a ratio of the remaining correspondences ∥C_{q}_{^{−t}}ₚ∥′ (after replacing q by [symbol] ) with the number of geometric correspondences ∥C_{gp}∥ in the matching pair (q, p). The synthetic pair may be considered a valid synthetic pair or valid pair if its geometric consistency score exceeds a threshold τ. The geometric consistency score may be used to rank the synthetic pairs according to the level of preservation of their geometry.

In some embodiments, the generative model can be considered to produce synthetic variants that should not shift or alter local features in terms of their geometry. Therefore, a geometric transformation between an image and its variant should be an identity transformation. A self-consistency check can be performed to validate each synthetic image. For example, a pair can be created between the original image and its synthetic variant, i.e. (q, [symbol] ) for each text prompt t. If the geometric transformation of the pair is the identity transformation, then the synthetic image is a valid image.

Further, an improved training process of the image retrieval model is provided based on an extended dataset. The extended dataset may include real and synthetic images. The image retrieval model may be a deep learning-based model such as CNN-encoder or can be any known model such as HOW or FIRe. The existing image retrieval models are normally trained using contrastive loss function (as defined in Equation 1) on the set of training tuples comprising of real images only. In the present disclosure, due to the use of synthetic images the loss may be computed over original as well as synthetic tuples.

$${ℒ}_{c} ( {U}_{qp} ) = {‖ f ( q ) - f ( p ) ‖}_{2}^{2} + {\sum }_{m = 1}^{M} {[ μ - {‖ f ( q ) - f ( {n}_{m} ) ‖}_{2}^{2} ]}^{+} \qquad Equation 1$$

In Equation 1, f(x) represents aggregated feature vector for image x and can be computed as a weighted average of all local features. Moreover, u is a margin hyper-parameter, and [·]⁺ denotes a positive part function max (0,·).

The technique disclosed in the present disclosure can be utilized on top of existing image retrieval approaches or with any other AI task that requires model training based on image pairs and the known domain shifts can be synthesized by generative AI models while preserving geometry. For improve training of the image retrieval model, domain randomization is applied to improve resilience to domain shifts. For this, a random cropping mechanism may be used at first and then a data augmentation technique that mixes multiple augmentations such as AugMix. Further, an optimizer (such as AdamW optimizer) is used to facilitate training the image retrieval model for a longer time with a cosine learning rate schedule. As used herein, the term “Ret4Loc” may refer to the image retrieval models that may be trained using the training settings mentioned above.

The model can be trained in different ways by using synthetic variants. In some instances, the model training process may involve random selection of k tuples from a set of synthetic tuples that is generated using the original tuple. This approach may be called Ret4Loc-synth. In other instances, a filtered set of tuples may be used that contain valid synthetic tuples only. The model may then be trained using randomly selected k tuples from the filtered set of tuples and can be referred here as Ret4Loc-synth+. While in some other instances, geometry aware sampling can be performed to select k tuples from the filtered set of tuples. Each tuple in the filtered set of tuples may have a geometry consistency score s. The sampling of a valid synthetic tuple Ũ_{qp}^{t} may be performed proportionally to 1/s(\tilde{q}^{t}, p). Hence, the tuples with a larger drop in correspondences are picked with a higher probability. This weighing scheme may favor valid tuples that are “harder” and may be referred to as geometry-aware sampling. The models trained using geometry-aware sampling may refer herein as Ret4Loc-Synt++.

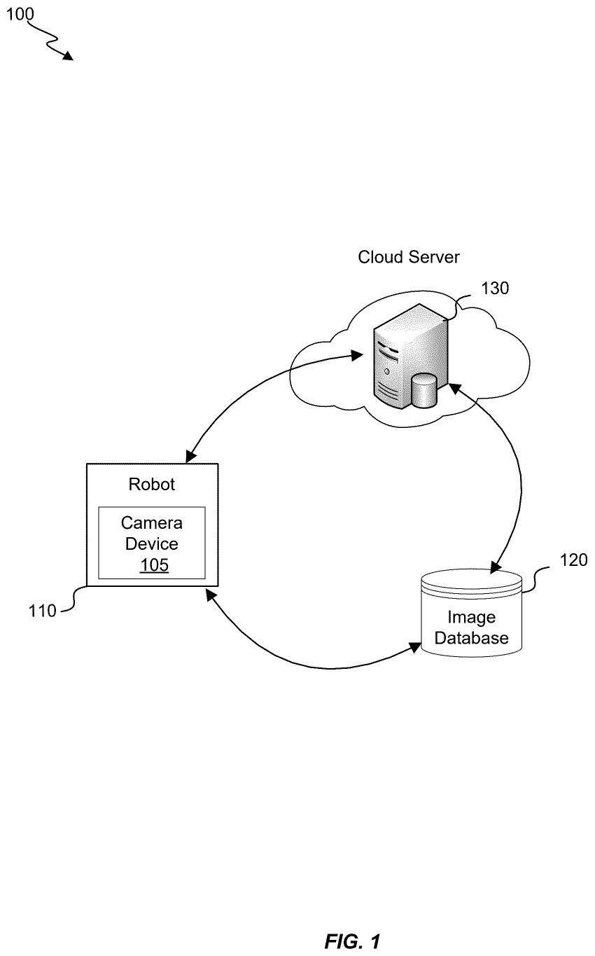

FIG. 1 shows an example network 100 for performing a method of visual localization to determine a pose of an autonomous mobile robot in accordance with an example implementation of the present disclosure. The example embodiment may be implemented with a robot 110, an image database 120, and a cloud server 130. The robot 110 can be of any autonomous or semi-autonomous mobile robotic platform or vehicle designed to move in various environments without or with little human intervention. The robot 110 perception system may include a camera device 105 along with other sensors (e.g., proximity sensor, Light Detection and Ranging (LiDAR), inertial sensor, Global Positioning System (GPS) etc.) to perceive their environment. The camera device 105 may include but not limited to Red, Blue and Green (RGB) cameras, depth cameras, stereo cameras or hyper spectral cameras. The robot 110 may utilize algorithms and artificial intelligence for decision-making and navigation within the environment. For accurate localization in both types of environments (i.e., indoor or outdoor), a navigation system of the robot 110 may purely rely on the perception system of the robot 110 without relying on any specific external equipment (e.g., beacons, tags, or Radio Frequency Identification (RFID)). The robot 110 may estimate its pose using visual localization based on the scene currently observed by the robot 110, in accordance with embodiments disclosed herein.

In some embodiments, the robot 110 may capture an image (also refer herein as query image) and send the image to the cloud server 130 via any wireless internet access such as 5G network, Wi-Fi etc. The cloud server 130 may run a visual localization service and process the query image received from the robot 110. The visual localization service may execute the visual localization method using the images from the image database 120. The image database 120 may be comprises of images of the environment in which the robot 110 move around. In response to the query image, the visual localization service running on the cloud server 130 may return the pose estimate of the robot 110. Multiple robots can be connected to the cloud server 130 and utilize the visual localization service to get an accurate estimate of their current position. The cloud server 130 acts as a shared brain for the robots 110.

In some other embodiments, if the environment is not big or does not require multiple robots, then the robot 110 may host the image database 120 in its memory and may run the visual localization method on its onboard computational unit. For example, a vacuum cleaner robot cleaning in a small home. The different aspects or scenes of the environment (i.e., home) can be captured using a small number of images, which can be easily accommodated in the built-in memory of the robot 110. Many modern robotic vacuum cleaners are designed to operate autonomously without requiring a constant internet connection for basic functionalities like cleaning and navigation. The core algorithms for Simultaneous Localization and Mapping (SLAM) and obstacle avoidance are executed locally on the robot 110 without the need for a continuous internet connection or with the cloud server 130.

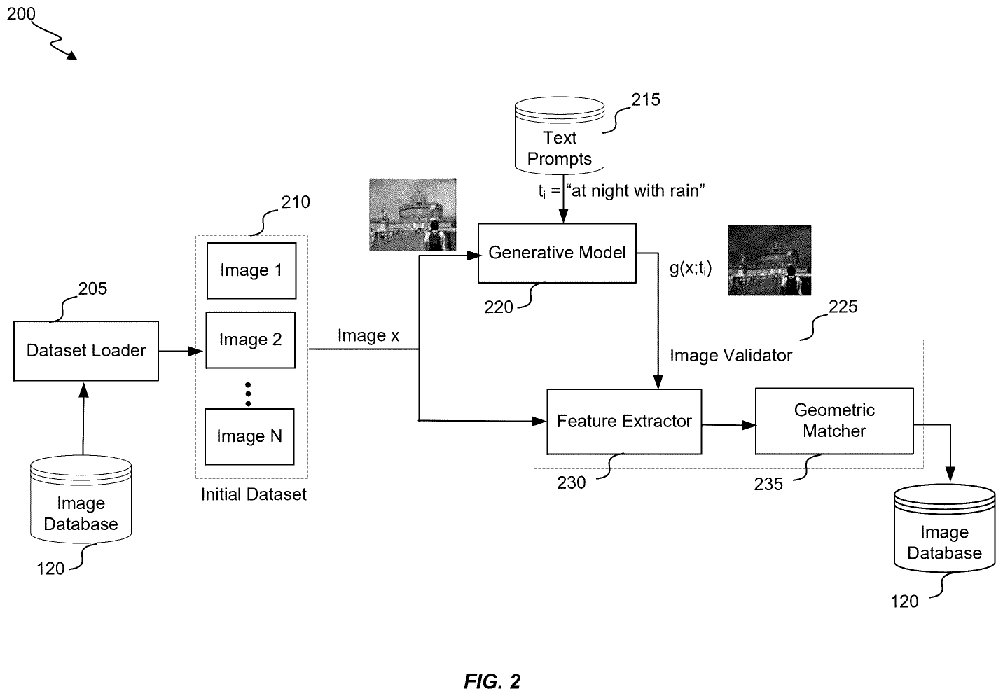

FIG. 2 shows an example block diagram to generate synthetic images for extreme domain shifts in accordance with some embodiments of the present disclosure. A dataset loader 205 may retrieve the initial dataset 210 from the image database 120. The initial dataset 210 may be comprised of images of the environment in which the visual localization is required by the robot 110. A set of text prompts 215 can be generated to describe changing conditions of the environment such as related to seasons, weather, lighting, or time of day for outdoor scenarios. In case of indoor environment, the set of text prompts 215 may include holiday- or event related changes related changes such as Christmas, Kwanzaa, Hanukkah, Easter, Sales events, more crowdy and the like. The set of text prompts 215 may comprise of all the changing conditions of the environment that can be clearly and concisely expressed via natural language.

To synthesize such challenging scenarios, generative models 220 can be used. The generative models 220 may include text-to-image generation models, for example, DALL-E, or Stable Diffusion and the like. In addition, image alteration models via a text prompt may also be used as the generative models 220 including but not limited to InstructPix2Pix, EMU Edit, or ControlNet. By using the generative models 220, multiple synthetic variants may be generated for every image in the initial dataset 210 based on the set of text prompts 215. For example, if g(·) be a generative model that takes as input an image x and a text prompt t, and produces [symbol] , a synthetic variant of image x with respect to text prompt t, i.e. [symbol] =g(x; t). For the training set D and a set of T textual prompts T={t₁, . . . , t_{T}}, an extended dataset can be generated which contains the original images as well as their T synthetic variants [symbol] =g(x; t), for every image in D and for all t={1 . . . T}.

In some instances, an image validator 225 can also be used to evaluate self-consistency of the synthetic images before saving them into the image database 120. The image validator 225 may include a feature extractor 230 and a geometric matcher 235. The feature extractor 230 may include local feature detector and descriptor e.g., R2D2, or SIFT and can be used to extract local features of the image. In some instances, local features may be available already for a dataset with 3D SfM maps. Since, map construction process is based on such local features. For each image in the initial dataset 210, the pairs can be created between the original image and synthetic image. For example, for an image x, the image pairs may be represented as (x, [symbol] ) for every text prompt t.

The geometric matcher 235 may compare the feature vectors of an image and with its synthetic variant. The geometric matcher 235 may compute geometric transformation between the images of a pair. The synthetic image may be considered valid if the geometric transformation of the image pair (x, [symbol] ) is identity transformation. The synthetic variants created by the generative model 220 can be valid if they did not shift or alter local features in terms of geometry. The geometric transformation between every image x and [symbol] may be the identity transformation.

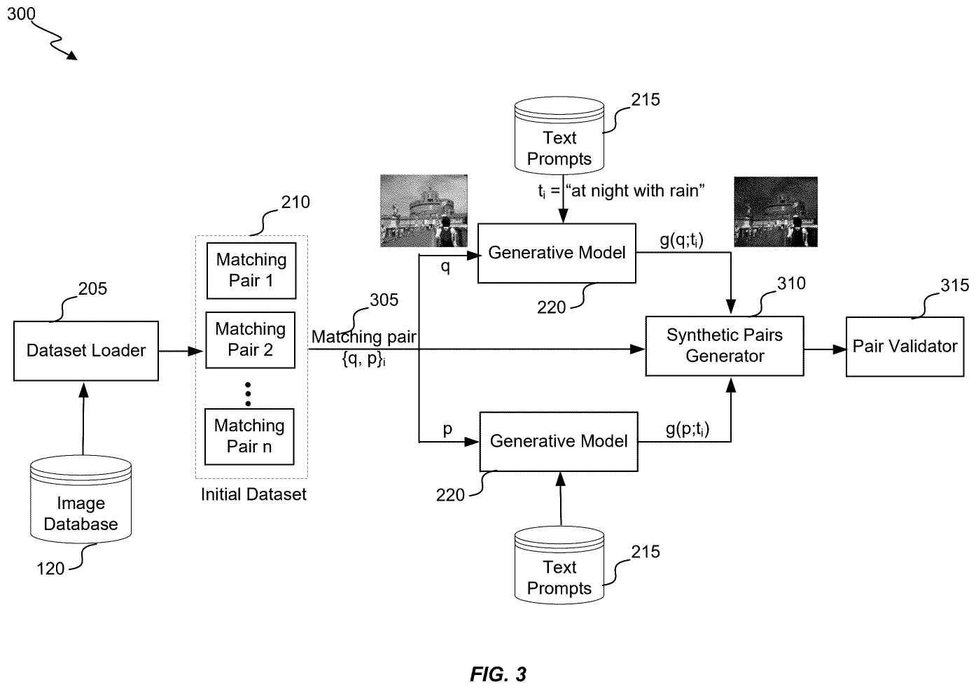

FIG. 3 illustrates another exemplary block diagram of generation of synthetic images for the extended dataset in accordance with an example implementation of the present disclosure. The dataset loader 205 may retrieve the initial dataset 210 from the image database 120. The initial dataset 210 may be comprised of matching pairs. Each image of the matching pair represents the same aspects or scene of the environment. For a matching pair (q, p) 305, either q or p can be used as input to the generative model 220 to create a synthetic variant for each of the text prompt t. A synthetic pairs generator 310 may create synthetic pairs or tentative pairs, either by combining q with synthetic variant of p or by combining synthetic variant of q with p. To avoid loss of generality, and since there may not be ordering in a pair, a set of possible tentative pairs for the matching pair (q, p) 305 can be expressed as in equation 2.

$$\tilde{P} ( q , p ) = \{ ( , p ) \vert t = 1 ¨ {N}_{t} \} ⋃ \{ ( q , ) \vert t = 1 ¨ {N}_{t} \} \qquad Equation 2$$

In Equation 1, Nₜ may represents total number of text prompts. To make sure that any pair (q, p)∈\tilde{P}(q, p) is a valid pair or not, a pair validator 315 may be utilized to validate each pair (q, p) from the set of tentative pairs \tilde{P}(q, p).

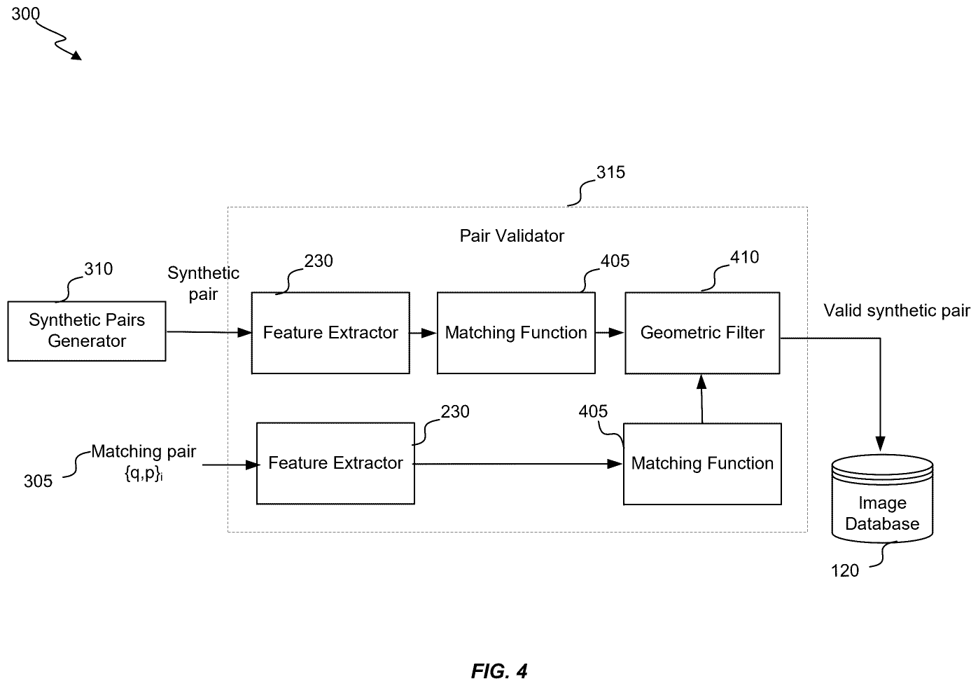

FIG. 4 illustrates an example implementation of the pair validator 315 to identify valid synthetic pairs in accordance with an embodiment of the present disclosure. The pair validator 315 may verify the geometry of the synthetic pairs automatically. Each image of the image pair may be represented as feature vector using the feature extractor 230. A matching function 405 can be any function which takes two images as input and provides a set of correspondences as an output. For example, if the task is in 3D, then the matching function 405 may perform matching over 3D models. The matching function 405 may be used to obtain a set of geometric correspondences between the images of the image pair (e.g., the matching pair 305 or synthetic pair).

According to an example embodiment, an area of interest may be determined initially using the matching pair (q, p) 305. The area of interest can be an arbitrary subset of image pixels akin to a segmentation mask. For example, the area of interest between images of the matching pair 305 may comprise of those pixels which describe the scene (e.g. landmark) and not occluding objects such as people. Depending on the nature of the initial dataset 210, the area of interest may be either known, or easy to determine automatically. The common visual localization datasets, for example, come with 3D SfM maps. Images from the matching pair 305 could be registered, and a set of 3D co-observations that the two images share could define a suitable area of interest. In some other instances, when the initial dataset 210 comprises of generic set of image pairs, such as landmark images sets which do not have extra information. For this type of dataset, any matching framework, such as RANSAC, deep learning-based alternatives (e.g. Deep-Matching) or even diffusion-based dense matching can be utilized as the matching function 405. These matching frameworks may have feature extractor 230 built-in.

In some instances, the generative model 220 may be considered that do not shift or alter local features in terms of geometry. Then the geometric transformation between every image x and [symbol] may be the identity transformation. Hence, any verified geometric transformation between (q, p) may remain preserved also for every pair in \tilde{P}(q, p). The geometric transformation may be available for every matching pair (q, p) of the initial dataset 210 as a by-product of the process of computing the area of interest. The geometric transformation can be extracted either via pose registration process on the 3D SfM maps, or directly computed during geometric matching. The geometric transformation for every tentative pair (containing at least one synthetic image) can be obtained in a similar manner. The validity of the tentative pair may be obtained by calculating the number of local geometric correspondences that abide by known transformation using a geometric filter 410. This process can be much faster in practice as it only requires extracting local features for each of the images and then matching them per pair. A tentative pair from P (q, p) may be declared valid if the absolute or relative number of local key point correspondences inside the area of interests of the two images exceed a threshold τ.

In other aspects of the present disclosure, a geometric consistency score may be computed to assess the degree to which a synthetic pair preserves location characteristics shared across the matching images. For example, ( [symbol] , p) represents the synthetic pair of the matching pair (q, p) 305 in which query image (q) is replaced by a synthetic variant obtained with text prompt t. If C_{qp}=c(·,·) denote the matching function 405 that returns a set of correspondences C_{qp}, i.e. a set of geometrically consistent local matches between q and p. The geometric correspondences C_{q}_{^{−t}}ₚ can be computed for the synthetic pair and may be filtered using the geometric filter 410 in such a way that only correspondences that existed in the original pair (q, p) are kept: ∥C_{q}_{^{−t}}ₚ∥′=C_{q}_{^{−t}}ₚ∥∩C_{q}_{^{−t}}ₚ∥. The geometric filter 410 may compute the geometric consistency score by taking a ratio of correspondences remaining after replacing q by [symbol] in the matching pair with the set of correspondences of the matching pair (q, p) 305. The geometric consistency score may be defined as in Equation 3.

$$S ( {\tilde{q}}^{t} , ρ ) = \frac{{‖ {C}_{{\tilde{q}}^{t} , p} ‖}^{′}}{‖ {C}_{qp} ‖} \qquad Equation 3$$

The geometric consistency score may be used to rank synthetic pairs according to the level of preservation of their geometry.

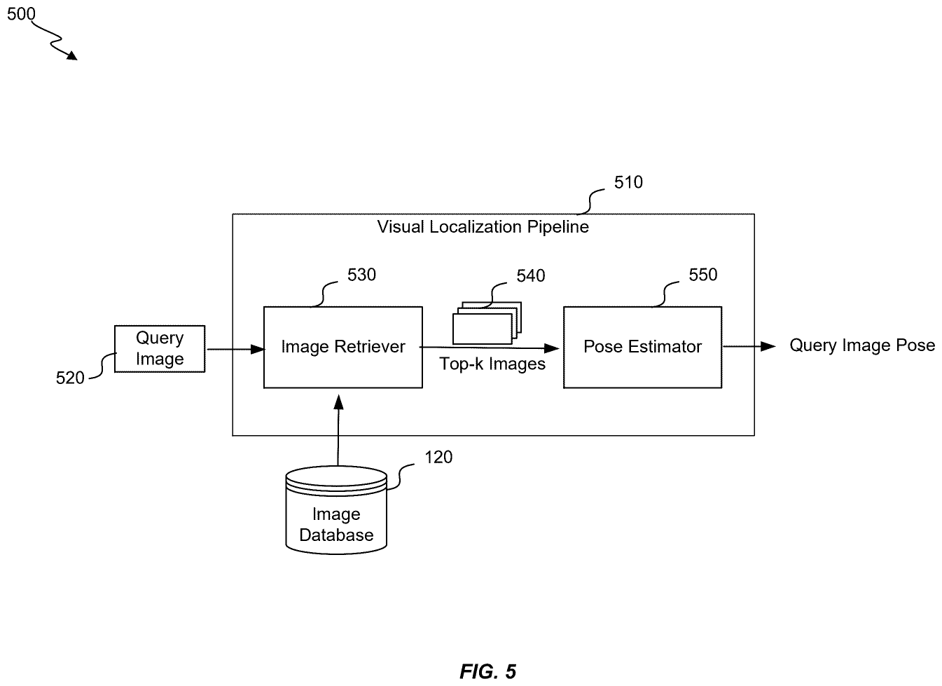

FIG. 5 shows exemplary components of a visual localization pipeline 510 that can be implemented using the example network 100 of FIG. 1, in accordance with an example implementation of the present disclosure. The visual localization pipeline 510 may include an image retriever 530 and a pose estimator 550. The visual localization pipeline 510 can be implemented as a service on the cloud server 130 can provide localization service to multiple robots 110 working in the environment. In some instances, the visual localization pipeline 510 can be implemented inside the robot 110 using its onboard computational unit for environments that can be represented by a small image database. A query image 520 may be generated by the camera device 105 of the robot 110. The image retriever 530 may process the query image 520 and return top-k images 540 from the extended dataset. The extended dataset may be retrieved from the image database 120 and may be comprised of real and synthetic images. The top-k images 540 may be comprises of images that are most similar to the query image 520.

The pose estimator 550 may then estimate the pose for the query image 520 by using the camera pose information assigned to the retrieved images. In some instances, only the top-k images 540 may be used to predict the camera pose. The pose can be predicted either by interpolating or approximating the poses from the top-k images 540, or by using a complex method for increased precision. The complex method may include utilization of local or global 3D maps created via Structure from Motion (SfM) such as COLMAP and the query image 520 pose can be estimated by registering it in the 3D map.

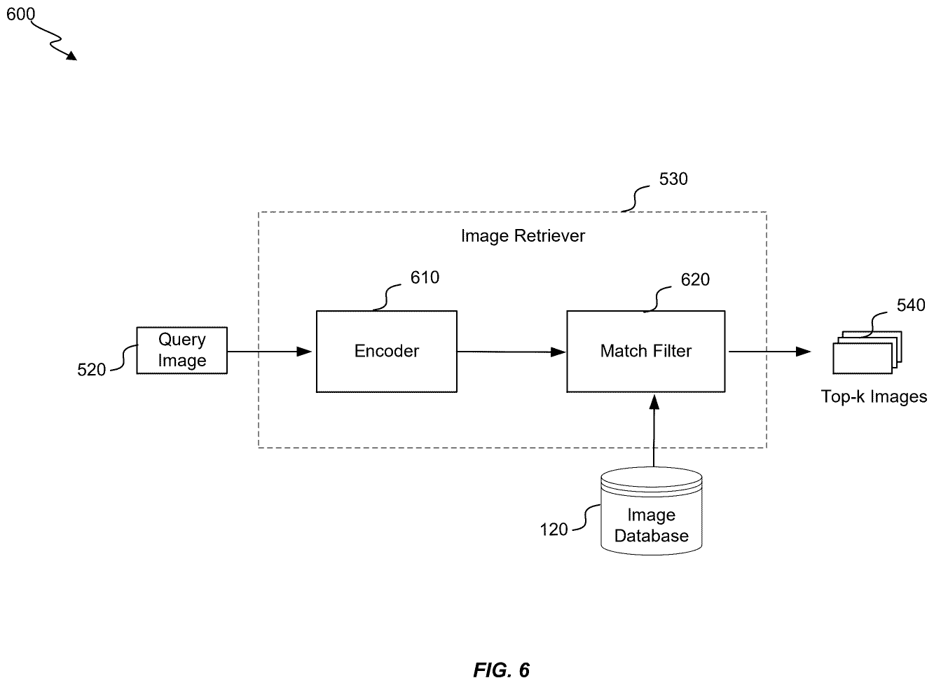

FIG. 6 illustrates exemplary components of the image retriever 530 of the example visual localization pipeline of FIG. 5, in accordance with an example implementation of the present disclosure. In the example embodiment, the image retriever 530 may include an encoder 610 and a match filter 620. The encoder 610 may comprise of deep learning-based model such as CNN-encoder and can provide local features of the query image 520. The match filter 620 may compare the local features of the query image 520 with pre-computed feature vectors of images of the extended dataset. Based on a similarity measure, the match filter 620 may rank the images of the extended dataset and may return the top-k images 540.

In some embodiments, the image retriever 530 may utilize other image retrieval approaches for place recognition such as techniques based on handcrafted local descriptors and bag-of-words representations, or more sophisticated aggregation techniques e.g., Fisher Vectors or ASMK. With the rise of deep learning, retrieval techniques started using one global descriptor per image for retrieval, either produced directly or obtained by aggregating local activations of the deep model. For example, deep metric learning may be applied on large sets of landmark images mined from the web in order to learn global features that excel at the task of place recognition. The retrieval techniques that utilize CNN-based local features are typically outperform other techniques.

The image retriever 530 can execute any image retrieval approach including but not limited to: HOW, FIRe. The retrieval approaches that best correlate with localization accuracy are HOW and FIRe. They employ a global contrastive loss to learn a model whose local features are then used with match kernels such as ASMK to perform image retrieval. ASMK is a matching process defined over selective matching kernels of local features. ASMK is a much stricter and more precise matching function than comparing global representations.

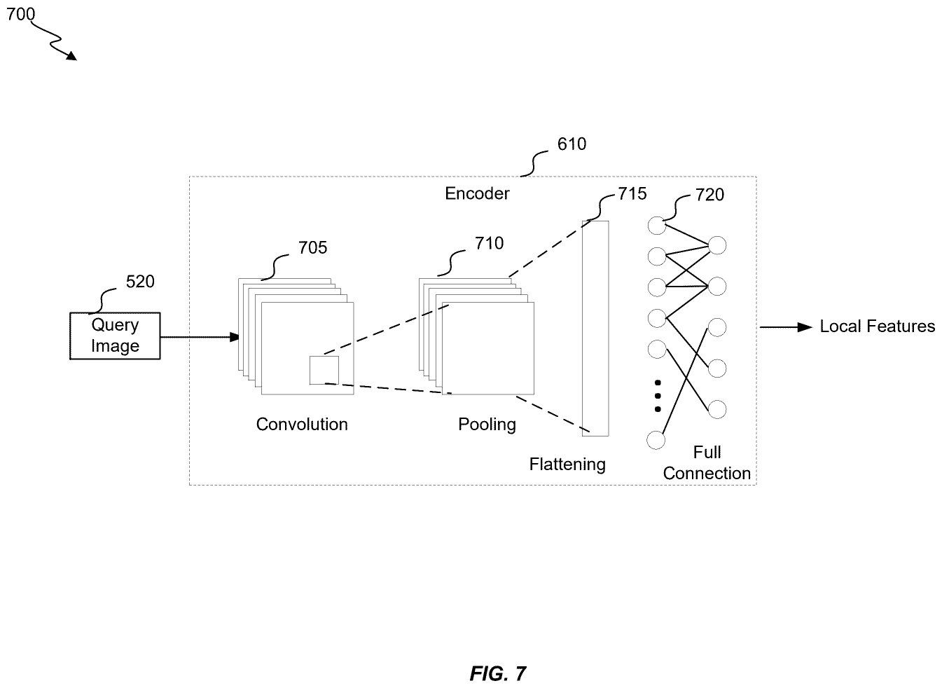

FIG. 7 shows an example implementation of the encoder 610 used in the image retriever, in accordance with the example implementation of FIG. 6. The encoder 610 can be a deep CNN model e.g., VGG16 or ResNet. The encoder 610 may include a convolution layer 705, a pooling layer 710, a flattening layer 715, and a fully connected layer 720. The query image 520 may be fed to the encoder 610 via a forward pass. The convolution layer 705 may extract local patterns using convolutional filters and may detect features like edges, textures, and simple shapes. The pooling layer 710 may down sample feature maps, reducing spatial dimensions and providing translation invariance, ensuring the model focuses on the most salient information in local regions. The flattening layer 715 may convert the spatially organized feature maps into a one-dimensional vector, preparing the data for input into fully connected layers. The fully connected layer 720 may convert global relationships between local features, combining information from various parts of the image to form a comprehensive representation for the final local feature descriptor. The output, typically extracted from an intermediate layer like the last fully connected layer and may serve as the feature vector encoding the query image 520. The feature vector may capture hierarchical visual representations learned by the CNN during training. A trained model such as the encoder 610 can efficiently transform the query image 520 into meaningful and compact feature representations suitable for various downstream tasks in computer vision such as visual localization.

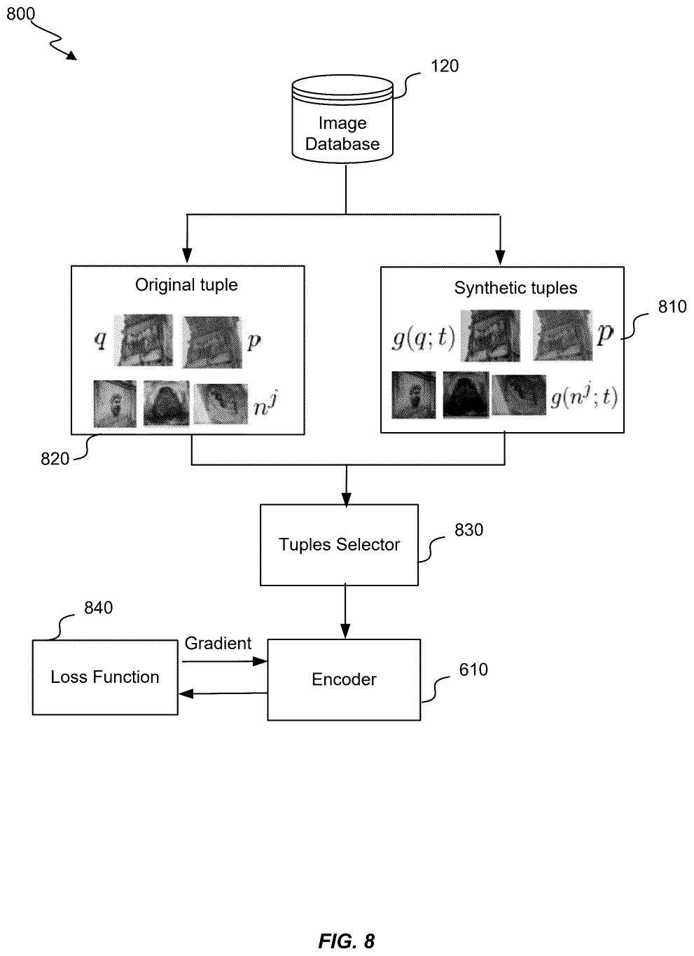

FIG. 8 illustrates an exemplary training method of the encoder 610 of FIG. 6 using the extended dataset in accordance with an example implementation of the present disclosure. The image database 120 may be used to load the extended dataset comprising of matching pairs and their multiple synthetic variants. The extended dataset can be arranged in the form of tuples. An original tuple 820 may comprise of the matching pair (q, p) and a set of M negatives or non-matching images. In some instances, synthetic tuples 810 may be obtained by substituting the query image q 520 and the set of M negatives of the original tuple 820 with their synthetic variants. The positive image p may not be substituted and therefore each synthetic tuple may contain both an altered and an original image p. To make sure negatives in the synthetic tuples 810 remain challenging, the synthetic variants can be selected in a consistent manner across a synthetic tuple e.g., synthetic variants from the same textual prompt can be used for the query and the set of M negatives.

For example, if a tuple U_{qp} corresponds to the matching pair (q, p) 305, then a synthetic tuple Ũ_{qp}^{t}=(\tilde{q}^{t}, p, ñ₁^{t}, . . . , ñ_{M}^{t}) for variant t (or corresponding to text prompt t) can be generated by replacing q with \tilde{q}^{t} and all the negatives nₘ with ñ_{M}^{t}. When the synthetic tuple 810 is used in the contrastive loss of HOW (Equation 1), the first part of the loss, which uses a synthetic \tilde{q}^{t} with an unaltered p, may bring the representations of the original positive image p and of the synthetic variant of the query q close to each other. At the same time, the loss pushes the synthetic variant of the query \tilde{q}^{t} away from the representations of all the synthetic negative images ñ_{M}^{t}, in the domain corresponding to the selected text prompt. Therefore, the query feature should be invariant to the different domain shifts described by the set of text prompts 215 and simultaneously for any domain shift, the query feature should be different enough from its associated negatives.

In some embodiments (e.g., Ret4Loc-Synth), a training dataset can be extracted from the extended dataset that may comprise of both the original tuple 820 and one or more synthetic tuples 810 sampled from the set of possible ones for the different prompts. A tuple selector 830 may select subset of tuples from the training dataset by uniformly sample K text prompts to select the synthetic tuples 810 among T options. For example, consider a set of K synthetic tuples Ũ={Ũ_{qp}¹, I . . . , Ũ_{qp}^{K}} corresponding to K≥1 selected variants. Then an extended set of tuples Ũ={U_{qp}, Ũ_{qp}¹, I . . . , Ũ_{qp}^{K}} may contains the original tuple 820 U_{qp} and K synthetic tuples. The extended set of tuples may be used to compute a loss function 840 to train the image retrieval model such as the encoder 610.

In some instances, the loss function 840 may be computed for the extended set of tuples Ũ by adding the individual losses incurred from the original tuple 820 and the synthetic tuples 810 as defined in Equation 4.

$${ℒ}_{c} ( \tilde{U} ) = {ℒ}_{c} ( {U}_{qp} ) + {\sum }_{k} {ℒ}_{c} ( {\tilde{U}}_{qp}^{k} ) \qquad Equation 4$$

In some other instances, a set of features can be aggregated from all variants of each image in the original tuple 820 independently, and then a single value of the loss function 840 value can be computed on the aggregated features. The set of features may be obtained from the encoder 610 output. For example, Q, P, Nₘ may represent the set of features extracted for the corresponding query, positive and each image of the set of M negatives, respectively, that appear in the extended set of tuples Ũ. An aggregation function φ may include simple averaging. The aggregation function φ may produce a single aggregated feature vector for each set of features Q/P/Nₘ. The loss function 840 can be computed using the aggregated vectors as defined in Equation 5. By computing the loss function 840 using Equation 5, the images in the original tuple 820 and the synthetic tuples 810 (i.e., original, and synthetic query, positive and negative images) may impact each other. The tuples may not be treated independently.

$${ℒ}_{c} ( \tilde{U} ) = {‖ ϕ ( Q ) - ϕ ( P ) ‖}_{2}^{2} + {\sum }_{m = 1}^{M} {[ μ - {‖ ϕ ( Q ) - ϕ ( {N}_{m} ) ‖}_{2}^{2} ]}^{+} \qquad Equation 5$$

In some embodiments of the present disclosure (e.g., Ret4Loc-Synth+), the geometric consistency score s can be used to select the synthetic tuples 810 to be used during training of the encoder 610 (or other known image retrieval models). The geometric consistency score s may vary in the range of [0, 1] and can measure the percentage of correspondences remaining for the matching pair after the query is altered. If the geometric consistency score s of the synthetic tuple is less than the threshold t then the synthetic tuple may be discarded. The synthetic tuples 810 having geometric consistency score s greater than the threshold t may be considered as valid tuples. The increase in the threshold t may led to selection of fewer synthetic tuples 810. During training of the image retrieval model, the selection of a subset of k tuples may be restricted to picking only from the valid tuples by the tuple selector 830.

In another aspect of the present disclosure (e.g., Ret4Loc-Synth++), each tuple in the filtered set of tuples may have a geometric consistency score s which correlates with the level of local appearance preservation. The geometric consistency score s may be utilized by the tuple selector 830 to compute the probability of sampling variants. The sampling of a valid synthetic tuple Ũ_{qp}^{t} may be performed proportionally to 1/s (\tilde{q}^{t}, p). Hence, the tuples with a larger drop in correspondences are picked more often. This weighing scheme may favor valid tuples that are “harder” and may be referred geometry-aware sampling. The geometry-aware sampling may only work well in conjunction with tuple filtering, as variants with very low geometric consistency may never be considered.

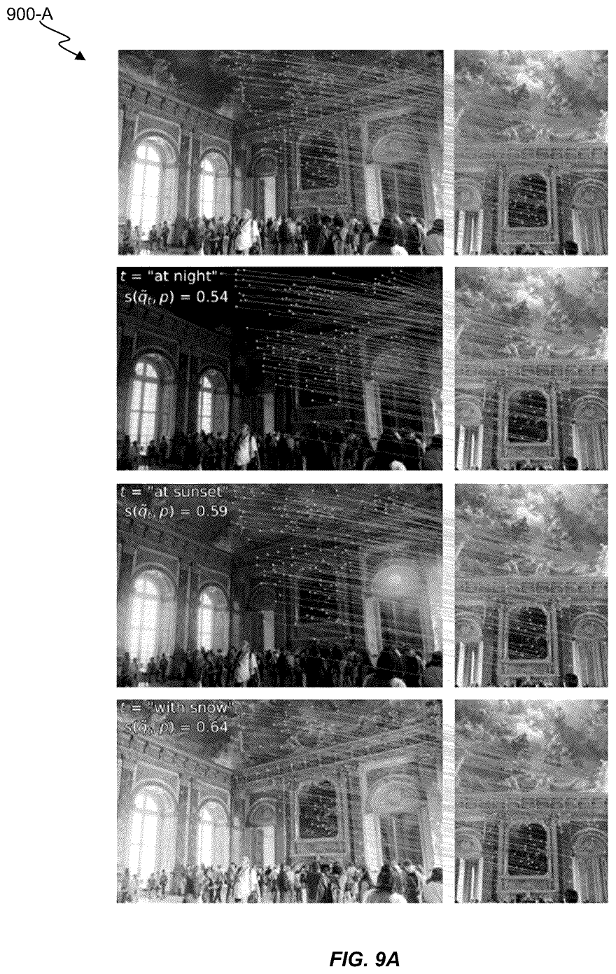

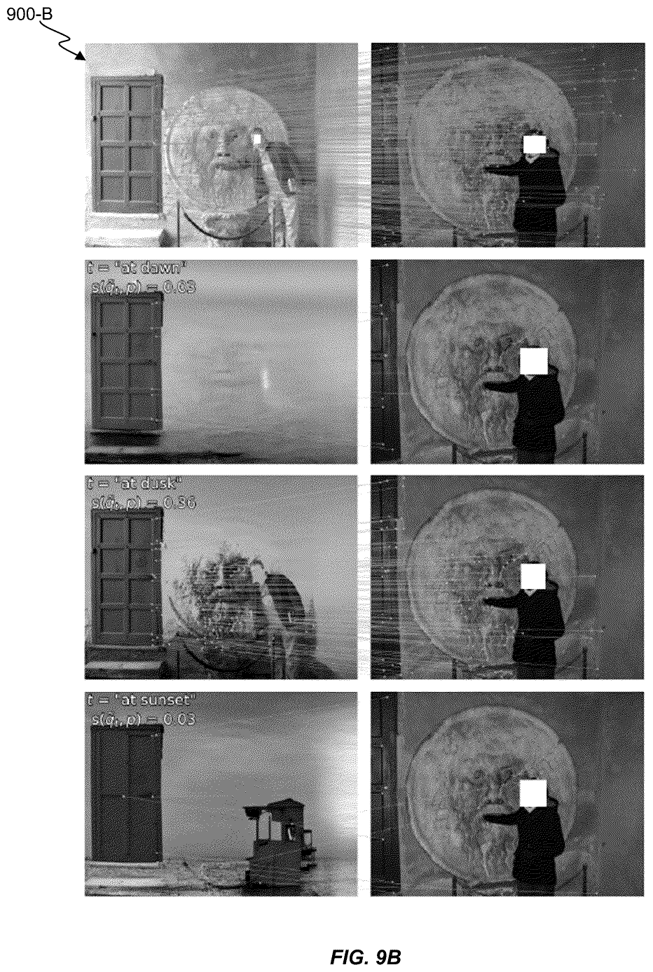

FIG. 9A shows an illustrative example of geometric correspondences between the matching pair 305 (at the top) and its good synthetic variants (bottom three) which preserved a certain fraction of geometric correspondences. The local geometric correspondences between images of the matching pair 305, before and after replacing the query image 520 with the synthetic variant for different text prompt are shown. The corresponding text prompt used to generate the synthetic variant and geometric consistency score s is mentioned on each pair.

FIG. 9B shows an illustrative example of geometric correspondences between the matching pair 305 (at the top) and its bad synthetic variants (bottom three) which did not preserve a certain fraction of geometric correspondences. In both figures FIGS. 9A and 9B, matches are discovered using the LightGlue algorithm.

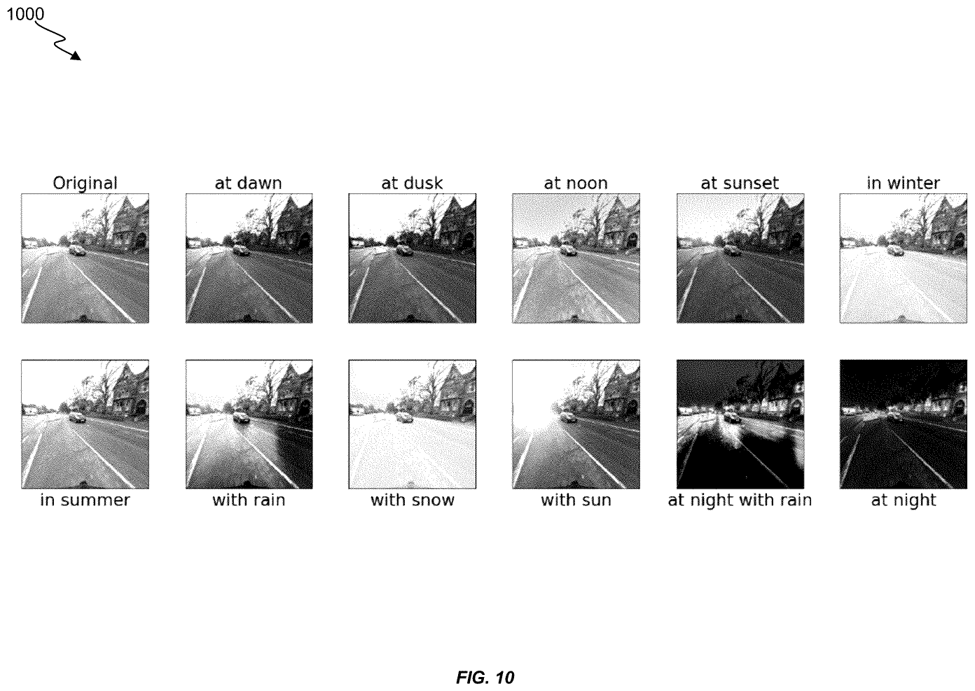

FIG. 10 shows an example illustration of 11 synthetic variants of an original image (top left) from RobotCar Seasons Dataset. The original image is shown on the top left, while the exact prompts used are shown over/under each generated image. Benchmarks which assess visual localization domain shifts have identified the common domain shifts, so they could measure the model's resilience to each of those shifts and their combinations. The domain shifts used by such benchmarks are selected in some embodiments. A small set of 11 textual prompts can be considered related to weather, seasons and time of day: ‘at dawn’, ‘at dusk’, ‘at noon’, ‘at sunset’, ‘in winter’, ‘in summer’, ‘with rain’, ‘with snow’, ‘with sun’, ‘at night with rain’, ‘at night’. The datasets generated when using this set of prompts are referred as the p11 datasets.

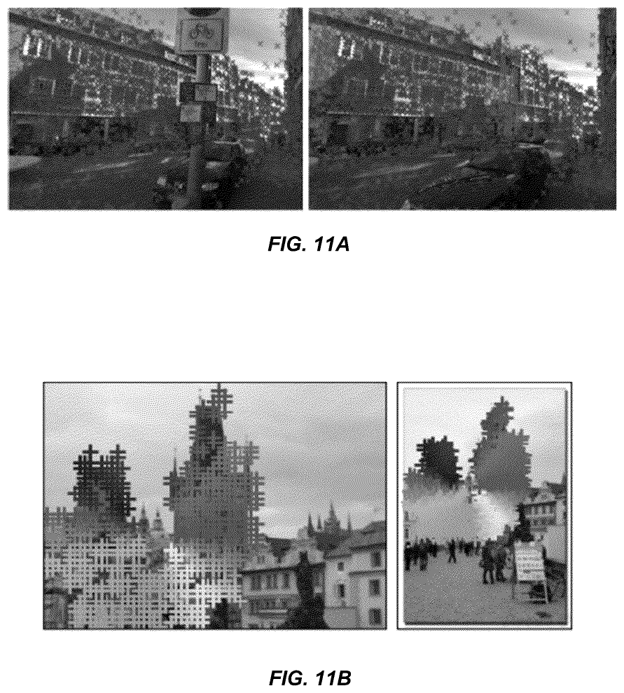

FIG. 11A shows an illustrative example of region of interest for the matching pair using 3D co-observations. The matching (green) and nonmatching (red) projected 3D key points or co-observations using the 3D SfM map are shown. FIG. 11B shows an illustrative example of region of interest for the matching pair using Deep Matching. The matching 2D key points are found automatically using the Deep-Matching algorithm. The same color between images means matched pixels. In both cases, the area of interest is composed of the image pixels where we have matching features.

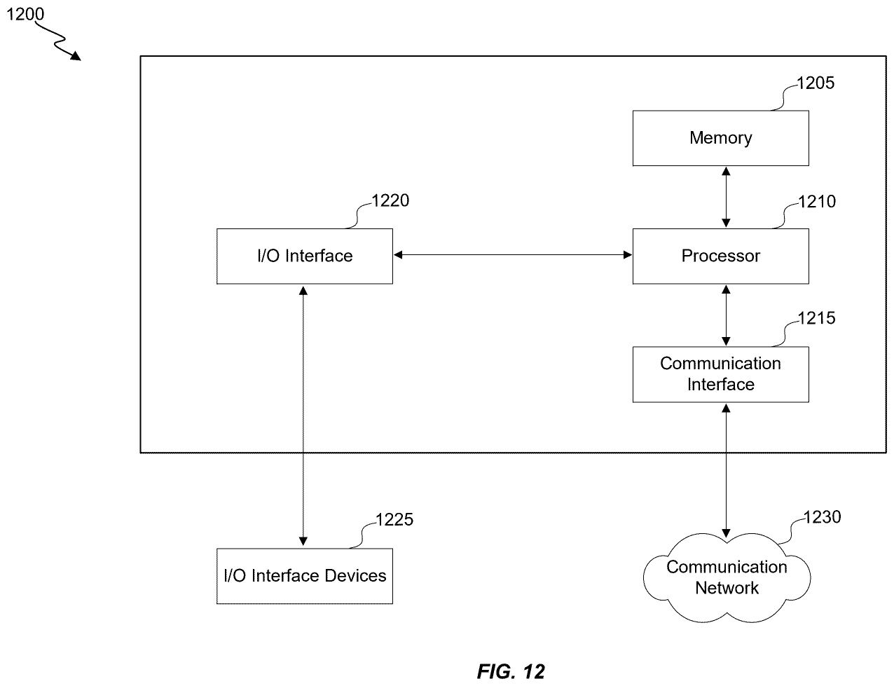

FIG. 12 is a block diagram of an example computing system 1200 that may be utilized to perform one or more aspects of the disclosure described herein. For example, in some implementations, the example computing system 1200 may be utilized to generate, train, and/or deploy a model to estimate the pose of the robot 110. The example computing system 1200 typically includes at least one processor 1210 that communicates with several peripheral devices via buses. These peripheral devices may further include, for example, a memory 1205 (e.g., RAM, a magnetic hard disk or an optical storage disk), Input and Output (I/O) interface devices 1225 via an I/O interface 1220 and a communication network 1230 via a communication interface 1215.

The I/O interface devices 1225 allow user interaction with the example computing system 1200. Input interface devices may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into the example computing system 1200 or onto the communication network 1230. Output interface devices may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from the example computing system 1200 to the user or to another machine or computing device.

The communication interface 1215 provides an interface to the communication networks 1230 and is coupled to corresponding interface devices in other computing devices. Some of the examples of the communication interfaces 1215 are a modem, digital subscriber line (“DSL”) card, cable modem, network interface card, wireless network card, or other interface device capable of wired, fiber optic, or wireless data communications.

Storage systems store programming and data constructs that provide the functionality of some, or all of the modules described herein. These software modules are generally executed by the processor 1210 alone or in combination with other processors. The memory 1205 used in the example computing system 1200 can include several memories including a main random-access memory (RAM) for storage of instructions and data during program execution, a mass storage device that provides persistent storage for program and data files, and may include a hard disk drive, a floppy disk drive along with associated removable media, a CD-ROM drive, a read only memory (ROM) in which fixed instructions are stored, an optical drive, or removable media cartridges. The modules implementing the functionality of certain implementations may be stored in the mass storage system, or in other machines accessible by the processor(s) 1210 via the I/O interface 1220.

The example computing system 1200 can be of varying types including a workstation, server, computing cluster, blade server, server farm, or any other data processing system or computing device. Due to the ever-changing nature of computers and networks, the description of the example computing system 1200 depicted in FIG. 12, is intended only as a specific example for purposes of illustrating some implementations. Many other configurations of the example computing system 1200 are possible having more or fewer components than the computing device depicted in FIG. 12.

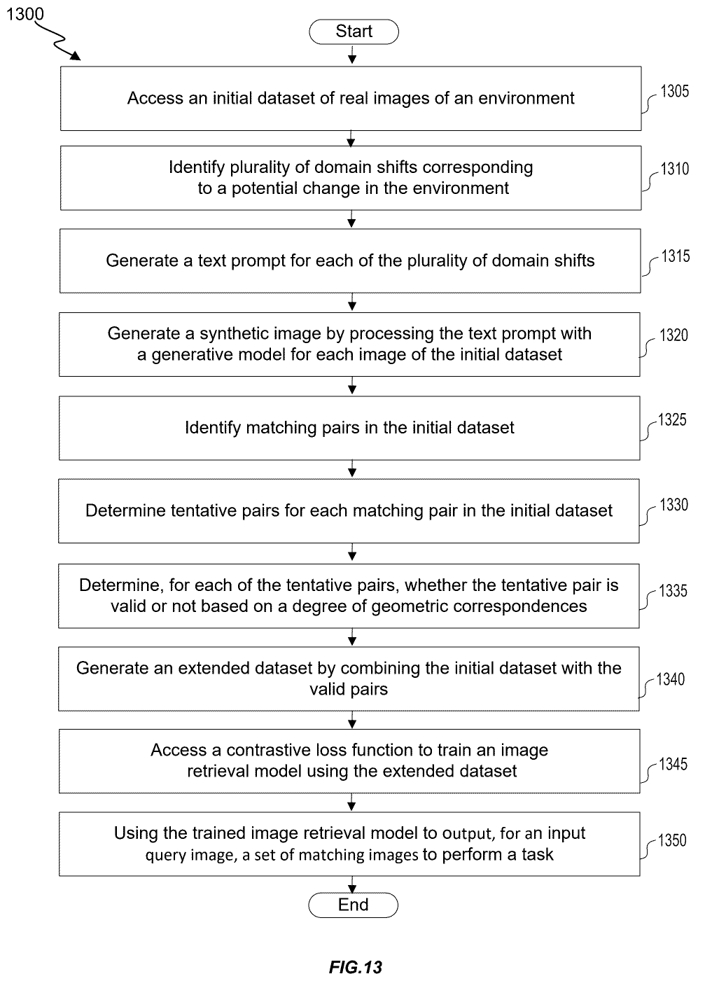

FIG. 13 illustrates an example flow of a computer implemented method 1300 for enhanced image retrieval model according to an example embodiment. Referring to FIG. 13, at block 1305, the initial dataset 210 of real images of an environment is accessed, where for each image of the initial dataset 210 there exists at least one matching image in the initial dataset 210 and a set of non-matching images, the matching image represents similar scene of the environment as in the image of the initial dataset 210. At block 1310, a plurality of domain shifts are identified, where each of the plurality of domain shifts corresponds to a potential change in the environment.

At block 1315, a text prompt is generated for each of the plurality of domains shifts. At block 1320, a synthetic image is generated by processing the text prompt with a generative model for each image of the initial dataset 210. At block 1325, matching pairs in the initial dataset 210 are identified, each matching pair comprises images that captured similar aspects or scene of the environment. At block 1330, tentative pairs are determined for each matching pair in the initial dataset, the tentative pairs are generated either by combining first image of the matching pair with the synthetic variant of second image of the matching pair or by combining the synthetic variant of the first image with the second image of the matching pair. At block 1335, each of the tentative pairs is determined valid or not based on a degree of geometric correspondence. At block 1340, an extended dataset is created by combining the initial dataset 210 with the valid pairs. At block 1345, a contrastive loss function is accessed to train an image retrieval model using the extended dataset. At block 1350, the trained image retrieval model outputs an accurate set of matching images to localize a position and/or orientation of the camera device 105 based on the input query image.

### Examples

An example implementation of the disclosed methods to achieve enhanced image retrieval models (or Ret4Loc models) is provided on 5 visual localization and 1 place recognition datasets. Of those 6 datasets, 4 are for outdoor and 2 for indoor localization. Although some part of the disclosed methods explicitly targets outdoor localization, Ret4Loc models also give state-of-the-art results for indoor localization.

The SfM-120K dataset was used to train all Ret4Loc models. The dataset SfM-120k was augmented by generating 11 synthetic variants for each image with the process described in FIG. 2 and used them to build the synthetic tuples 810 that were used during model training. The localization accuracy was evaluated on five datasets from the Visual Localization Benchmark, such as RobotCar Seasons, Aachen Day-Night v1.1, Extended CMU Seasons, Gangnam Station B2 and Baidu Mall. For completeness, the models were also tested for place recognition on the popular Tokyo 24/7 dataset.

The public instructPix2Pix model was used for generating synthetic variants. The 20 inference sampling steps were used for diffusion, and the text prompt and image guidance scale were set to 10 and 1.6, respectively. LightGlue was utilized as the matching function 405 to estimate the geometric consistency score s that was used for filtering or sampling synthetic variants.

The Ret4Loc models were built on top of the HOW codebase. The models were trained as explained in the description of FIG. 8. ResNet50 models were used as the encoder 610. A randomly resized crops of size 768×768 were used during training as additional data-augmentation in order to provide the network with fixed sized inputs. Based on preliminary experiments, it was found that using the original plus two synthetic variants (K=2) provided the best results. At test-time, multi-scale queries were used together with ASMK matching. A large variance in performance was observed when running the exact same training setup with different seeds. To get more robust results, the results are reported here after averaging the weights of 3 models that were trained from 3 different seeds.

To measure visual localization performance, the Kapture localization toolbox was used. In the retrieval step of this toolbox, a retrieval model produces a shortlist of the top-k nearest database images per query. For this example implementation, the retrieval model was replaced with the public HOW or FIRe models, or with one of the disclosed Ret4Loc Models. The rest of the pipeline, i.e., the pose estimation step, was shared across all experiments, and follows two of the protocols: a) pose approximation with equal weighted barycenter (EWB) using the poses of the top-k retrieved database images; or b) pose estimation with a global 3D-map (SfM) and R2D2 local features.

Two methods, HOW and FIRe designed for landmark image retrieval, were found to be state-of-the-art for the localization. In TABLE 1, the results are presented for several Ret4Loc-HOW models trained under different setups. The results are reported for different flavors of Ret4Loc models training with and without the use of synthetic variants and geometric consistency. In Table 1, VMix refers to the use of variant mixing with Eq. (4) instead of summing the different losses. Similarly, Filt. refers to synthetic tuple filtering and GaS to geometry-aware sampling.

It can be observed that the basic Ret4Loc-HOW setup (row 2) already brings some consistent gains over HOW. Using synthetic variants during training further improves performance even without any filtering (rows 3-4). In addition, mixing the variants generally improves performance (rows 3 vs. 4) in all datasets apart from RobotCar-Night. By inspecting the complete set of results on 6 datasets, overall consistent gains can be observed when incorporating synthetic data during training. From rows 5 and 6, it appears that the top performance can be obtained in all datasets except RobotCar-Night by incorporating geometric information, either as a way of filtering or as sampling the synthetic variants.

TABLE 1
Effect of synthetic data and geometric consistency

| | | | | | | | | | | | RobotCar- | | | |
|---|---|---|---|---|---|---|---|---|---|---|---|---|---|---|
| | | | | | RobotCar-v2 | | ECMU-val | | RobotCar-Day | | Night | | Tokyo 24/7 | |
| | | | | | EWB (top-1) | | EWB, (max) | | SfM, (max) | | SfM, (max) | | Recall@k | |
| | Model | VMix | Filt. | GaS | .5 m/5° | 5 m/10° | .5 m/5° | 5 m/10° | .25 m/2° | .5 m/5° | .25 m/2° | .5 m/5° | R@1 | R@10 |
| 1 | HOW | — | — | — | 29.8 | 74.4 | 25.9 | 81.1 | 52.6 | 81.1 | 17.4 | 35.0 | 89.2 | 96.5 |
| 2 | Ret4Lc- | — | — | — | 30.6 | 75.0 | 33.4 | 88.6 | 52.8 | 81.5 | 21.8 | 40.4 | 89.2 | 97.1 |
| | HOW | | | | | | | | | | | | | |
| 3 | Ret4Loc- | — | — | — | 31.5 | 75.9 | 33.4 | 88.0 | 52.8 | 81.1 | 25.1 | 47.1 | 88.9 | 96.2 |
| 4 | HOW + | ✓ | — | — | 31.7 | 76.3 | 34.3 | 88.6 | 52.7 | 81.2 | 23.0 | 43.6 | 90.5 | 96.2 |
| | synthetic | | Variations using geometric consistency | | | | | | | | | | | |
| 5 | | ✓ | ✓ | — | 31.8 | 77.1 | 34.4 | 88.8 | 52.8 | 81.5 | 22.1 | 43.7 | 90.2 | 96.2 |
| 6 | | ✓ | ✓ | ✓ | 31.3 | 76.4 | 34.5 | 89.1 | 53.0 | 81.4 | 21.0 | 41.7 | 91.1 | 97.1 |

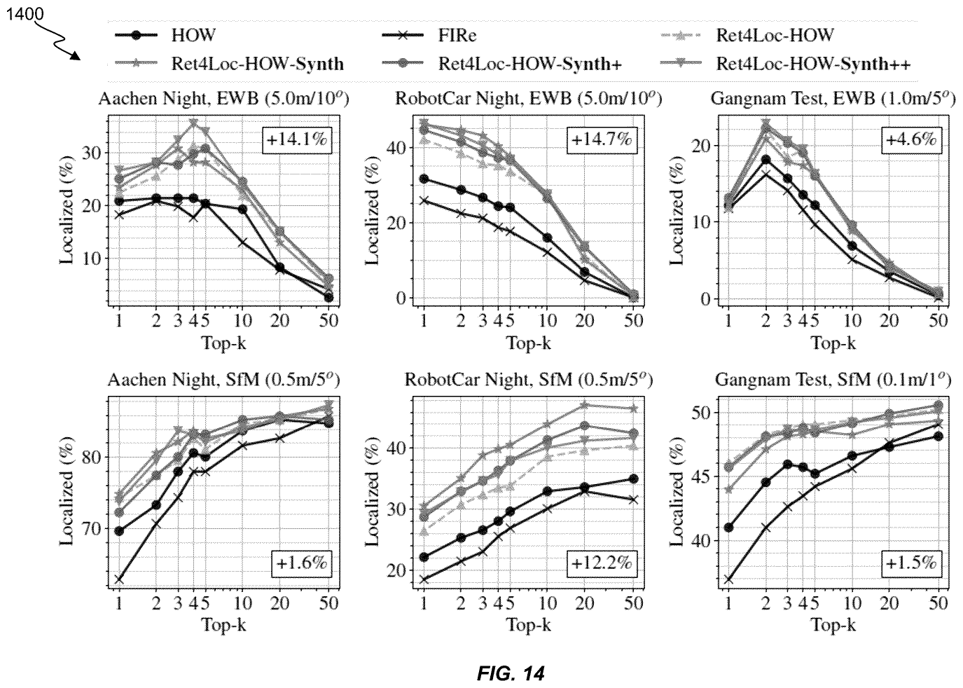

FIG. 14 shows localization accuracy results as a function of top k retrieved images for Ret4Loc models and state of the art in accordance with an example implementation of the present disclosure. In FIG. 14, the results of different variants of the disclosed method are compared with HOW and FIRe. The top row shows obtained results using pose approximation protocol (EWB) and the bottom row represents Structure from Motion (SfM) based protocol. The superiority of all Ret4Loc models can be observed across different protocols and top-k values, with gains exceeding 10% in localization accuracy for the case of night queries. The right-most plots show results on Gangnam Station B2, a dataset for indoor localization. It can be observed that strong augmentations help indoor localization as well. Moreover, the addition of synthetic data tailored to outdoor domain shifts does not hurt indoor performance, making Ret4Loc the state-of-the-art retrieval method for both indoor and outdoor localization.

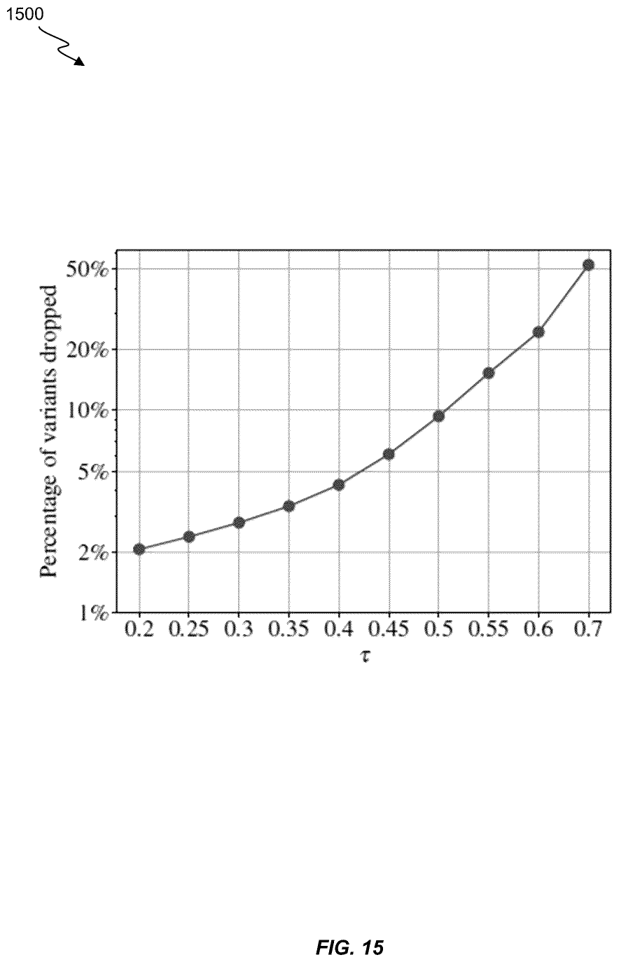

FIG. 15 shows a percentage of synthetic pairs dropped for different thresholds t on geometric consistency score s in accordance with an example implementation of the present disclosure. Using the RobotCar dataset, the FIG. 15 shows that the percentage of synthetic pairs that would be dropped for different thresholds t on the geometric consistency score s.

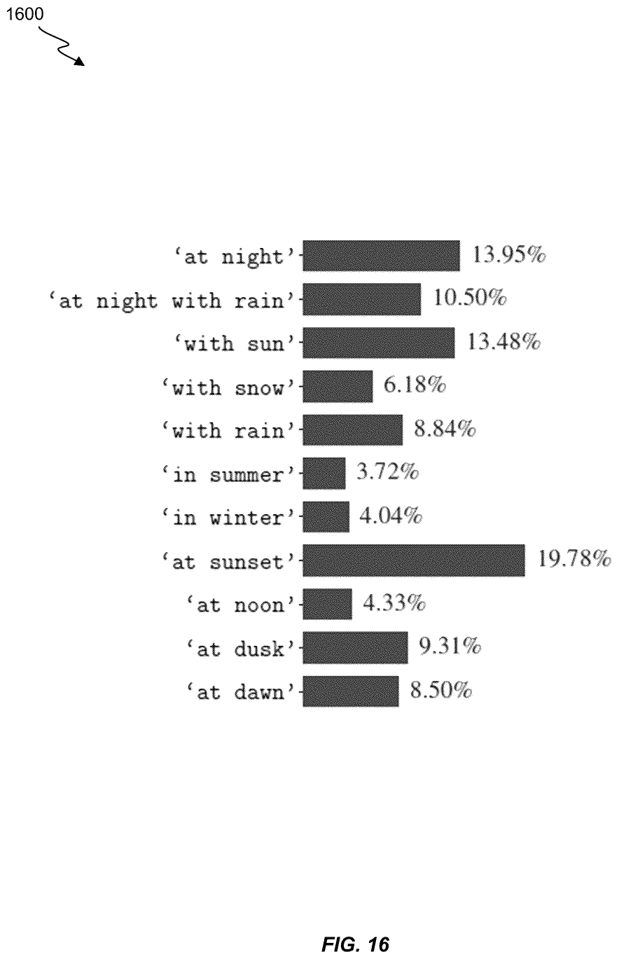

FIG. 16 shows the percentage of synthetic pairs dropped per text prompt for T=0.5 in accordance with an example implementation of the present disclosure. The prompt ‘at sunset’ has a much higher probability of being dropped may be due to the strong colors of sunset images dominate after alteration in many cases, making geometric consistency fail.

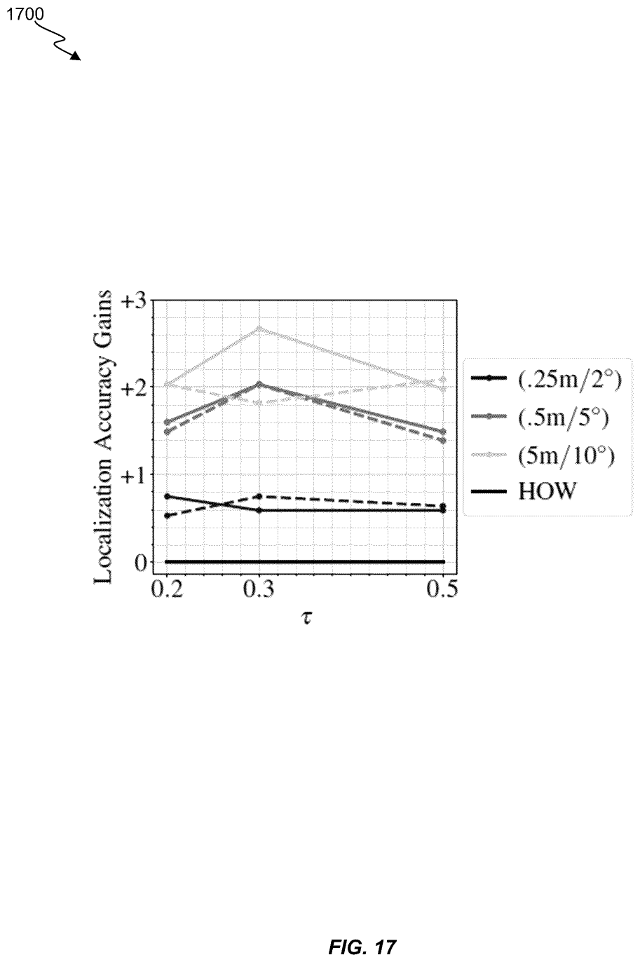

FIG. 17 shows relative localization accuracy gains on Robotcar-v2 dataset for different thresholds t for Ret4Loc-HOW-Synth+ (solid lines) and Ret4Loc-HOW-Synth++ (dashed lines) for localization across three error thresholds, in accordance with an example implementation of the present disclosure. The FIG. 17 shows the effects of different values of threshold t and presents gains on RobotCar-v2 for different values of τ with and without geometric-aware sampling. The performance is generally consistent for τ=[0.2, 0.3] and slightly dropping for t=0.5. The optimal value of t may be selected among τ=[0.2, 0.3] via a validation set. For the two named Ret4Loc models, Ret4Loc-HOWSynth+ uses τ=0.3 and Ret4Loc-HOW-Synth++ uses t=0.2.

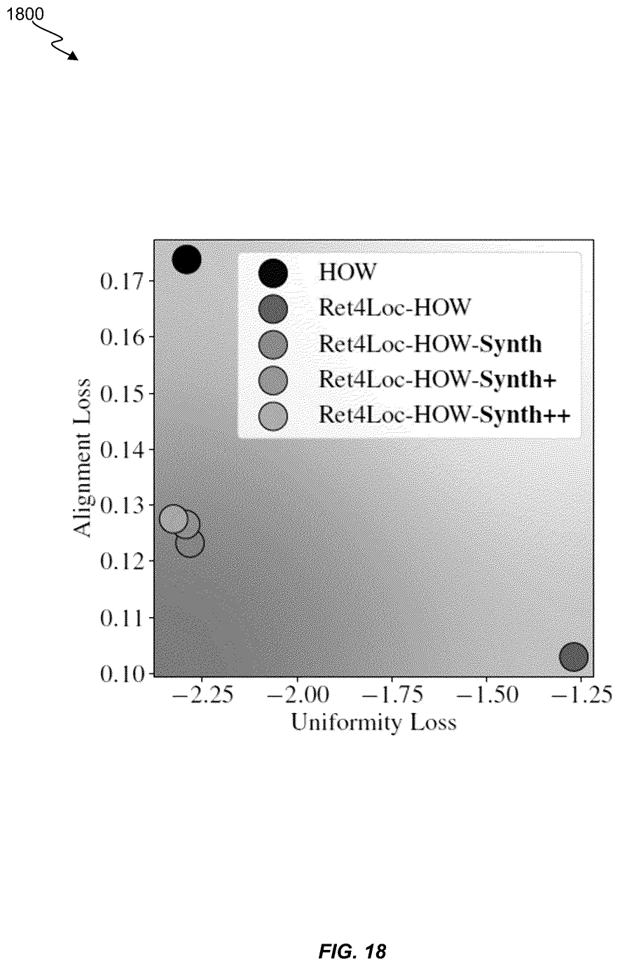

FIG. 18 shows analysis results of alignment loss versus uniformity loss using pre-extracted features from a validation set of SfM-120K, in accordance with an example implementation of the present disclosure. In order to better understand how individual model components impact representations, the features learned by the baseline HOW model and 4 of our models Ret4Loc-HOW, Ret4Loc-HOWSynth, Ret4Loc-HOW-Synth+ and Ret4Loc-HOW-Synth++ were analyzed. A sample of 1000 real images from the validation set of SfM-120K was obtained and the features were extracted for each of those images along with their 11 synthetic variants (as explained in FIG. 10). During feature extraction, the images were resized such that their longest side was 1024 pixels, and no cropping was applied to any of the images. In total, 12000 (128-dimensional each) image features were obtained for each model. Then, 1000 “classes” were created by grouping each real image with its synthetic variants and assigned a pseudo-label to each such pseudo-class. These pseudo-labels were used for ground-truth in the following analysis.

The alignment loss was measured between the feature of a real image and each of its 11 synthetic variants, and the uniformity loss was measured across all features. In FIG. 18, the HOW and Ret4Loc-HOW are located on the upper left and lower right corners, minimizing either the uniformity or alignment losses, respectively. Whereas the 3 models trained with synthetic data (Ret4Loc-HOW-Synth, Ret4Loc-HOW-Synth+ and Ret4Loc-HOW-Synth++) exhibit a better balance in the trade-off between the two losses, positioning closer to the lower left corner. This analysis was originally performed in the context of visual representation learning via self-supervised models, and it was observed that best performing models tend to position themselves towards the bottom left part of such 2D plots, as indicated by darker blue color in FIG. 18.

The devices and/or apparatuses described herein may be implemented through the hardware components and software components, and/or a combination thereof. For example, a device may be implemented utilizing one or more general-purpose or special purpose computers, such as, for example, processors, controllers, an arithmetic an logic units (ALUs), application specific integrated circuits (ASICs), digital signal processors (DSPs), digital signal processing devices (DSPDs), programmable logic devices (PLDs), field programmable gate arrays (FPGAs), micro-controllers, microprocessors, programmable logic units (PLUS) or any other electronic device designed to perform the functions described above. The processing device may run an operating system (OS) and one or more software applications that run on the OS. The processing device also may access, store, manipulate, process, and create data in response to execution of the software. For simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

Furthermore, when implemented in software, firmware, middleware, scripting language, and/or microcode, the program code or code segments to perform the necessary tasks can be stored in a machine-readable medium such as a storage medium. The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

Some embodiments of the present disclosure include a system including one or more data processors. In some embodiments, the system includes a non-transitory computer readable storage medium containing instruction which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein. The media may also include, alone or in combination with the program instructions, data files, data structures, and the like. The media may continuously store computer executable programs or may temporarily store the same for execution or download. Also, the media may be several types of recording or storage devices in a form in which one or a plurality of hardware components are combined. Without being limited to media directly connected to a computer system, the media may be distributed over the network. Examples of the media include magnetic media such as hard disks, floppy disks, and magnetic tapes; optical media such as CD-ROM and DVDs; magneto-optical media such as floptical disks; and hardware devices that are specially configured to store and perform program instructions, such as ROM, RAM, flash memory, and the like. Software codes can be stored in a memory that can be implemented within the processor or external to the processor. As used herein the term “memory” refers to any type of long term, short term, volatile, nonvolatile, or other storage medium and is not to be limited to any memory or number of memories, or type of media upon which memory is stored. Examples of a program instruction may include a machine language code produced by a compiler and a high-language code executable by a computer using an interpreter.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

The present description provides preferred exemplary embodiments only, and is not intended to limit the scope, applicability, or configuration of the disclosure. Rather, the present description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the present description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

What is claimed is:

1. A computer-implemented method comprising:
accessing an initial dataset of real images of an environment, wherein for an image of the initial dataset there exists at least one matching image in the initial dataset and a set of non-matching images, the matching image represents similar scene of the environment as in the image of the initial dataset;
identifying a plurality of domain shifts, wherein each domain shift of the plurality of domain shifts corresponds to a potential change in the environment;
generating, for each image of the initial dataset and for each domain shift of the plurality of domain shifts, a synthetic image;
identifying a plurality of matching pairs in the initial dataset, wherein each matching pair of the plurality of matching pairs comprises of a first image and a second image and both images captures similar aspects or scene of the environment;
determining, for each matching pair of the plurality of matching pairs in the initial dataset, a plurality of tentative pairs, wherein each tentative pair of the plurality of tentative pairs includes at least one synthetic image, the tentative pairs are generated by making image pairs of:
the first image with the synthetic images of the second image, and
the synthetic images of the first image with the second image;
determining, for each tentative pair of the plurality of tentative pairs, geometric correspondences;
determining, for each tentative pair of the plurality of tentative pairs, whether the tentative pair is a valid pair or not based on a degree of the geometric correspondences between images of the tentative pair inside an area of interest;
generating an extended dataset by combining the initial dataset with the valid pairs; and
training an image retrieval model using a contrastive loss function with weights assigned to each matching pair and corresponding valid pairs in the extended dataset.

2. The computer-implemented method of claim 1, further comprising:
receiving a query image; and
predicting a position and/or orientation of a camera device used to capture the query image by processing the query image using the image retrieval model.

3. The computer-implemented method of claim 1, further comprising:
determining a geometric transformation between the first image and the second image of a matching pair of the initial dataset; and
computing, for each tentative pair of the plurality of tentative pairs corresponding to the matching pair, a number of local geometric correspondences that satisfy the geometric transformation, wherein the tentative pair is valid if an absolute or relative number of local geometric correspondences inside the area of interest exceeds a threshold.

4. The computer-implemented method of claim 1, wherein the area of interest is determined by computing a matching function which returns a set of matches that are geometrically consistent between two images of a matching pair, the area of interest is composed of image pixels corresponding to the set of matches.

5. The computer-implemented method of claim 1, wherein the area of interest is determined based on identical sets of 3D co-observations between two images of a matching pair, the area of interest is composed of image pixels corresponding to matching 3D co-observations of the two images.

6. The computer-implemented method of claim 1, further comprising:
determining a first set of correspondences between images of a matching pair using a matching function;
determining a second set of correspondences between images of a tentative pair corresponding to the matching pair using the matching function; and
computing a geometric consistency score for the tentative pair, wherein:
identifying common geometric correspondences between the first set of correspondences and the second set of correspondences; and
computing the geometric consistency score by taking a ratio of the common geometric correspondences with the first set of correspondences in the matching pair.

7. The computer-implemented method of claim 1, further comprising:
generating a set of synthetic tuples based on the plurality of tentative pairs corresponding to the matching pair, wherein each tuple of the set of synthetic tuples comprises of images of a tentative pair and a set of non-matching images with the tentative pair;
selecting a subset of k tuples from the set of synthetic tuples, wherein:
the subset of k tuples is selected randomly, or
the subset of k tuples is selected based on a geometric consistency score, wherein the synthetic tuple with lower geometric consistency score has higher probability of selection; and
computing the contrastive loss function on the subset of k pairs to update model parameters.

8. The computer-implemented method of claim 1, wherein the image retrieval model is trained using an AdamW optimizer for longer time with a cosine learning rate schedule.

9. The computer-implemented method of claim 1, further comprising wherein the weights are proportional to the degree of geometric correspondence inside the area of interest between images of a matching pair or the valid pair.

10. The computer-implemented method of claim 1, wherein the plurality of domain shifts includes indoor and/or outdoor changing conditions of the environment, wherein:
the outdoor changing conditions include weather, season, or time of day, and
the indoor changing conditions include holiday or event related changes.

11. A system comprising:
one or more data processors; and
a non-transitory computer readable storage medium containing instructions which, when executed on the one or more data processors, cause the one or more data processors to perform actions including:
access an initial dataset of real images of an environment, wherein for an image of the initial dataset there exists at least one matching image in the initial dataset and a set of non-matching images, the matching image represents similar scene of the environment as in the image of the initial dataset;
identify a plurality of domain shifts, wherein each domain shift of the plurality of domain shifts corresponds to a potential change in the environment;
generate, for each image of the initial dataset and for each domain shift of the plurality of domain shifts, a synthetic image;
identify a plurality of matching pairs in the initial dataset, wherein each matching pair of the plurality of matching pairs comprises of a first image and a second image and both images captures similar aspects or scene of the environment;
determine, for each matching pair of the plurality of matching pairs in the initial dataset, a plurality of tentative pairs, wherein each tentative pair of the plurality of tentative pairs includes at least one synthetic image, the tentative pairs are generated by making image pairs of:
the first image with the synthetic images of the second image, and
the synthetic images of the first image with the second image;
determine, for each tentative pair of the plurality of tentative pairs, geometric correspondences;
determine, for each tentative pair of the plurality of tentative pairs, whether the tentative pair is a valid pair or not based on a degree of the geometric correspondences between images of the tentative pair inside an area of interest;
generate an extended dataset by combining the initial dataset with the valid pairs; and
train an image retrieval model using a contrastive loss function with weights assigned to each matching pair and corresponding valid pairs in the extended dataset.

12. The system of claim 11, wherein the area of interest is determined by computing a matching function which returns a set of matches that are geometrically consistent between two images of the matching pair, the area of interest is composed of image pixels corresponding to the set of matches.

13. The system of claim 11, wherein the area of interest is determined based on identical sets of 3D co-observations between two images of the matching pair, the area of interest is composed of image pixels corresponding to matching 3D co-observations of the two images.

14. The system of claim 11, wherein the actions further include:
determining a first set of correspondences between images of a matching pair using a matching function;
determining a second set of correspondences between images of a tentative pair corresponding to the matching pair using the matching function; and
computing a geometric consistency score for the tentative pair, wherein:
identifying common geometric correspondences between the first set of correspondences and the second set of correspondences; and
computing the geometric consistency score by taking a ratio of the common geometric correspondences with the first set of correspondences in the matching pair.

15. The system of claim 11, wherein the actions further include:
generating a set of synthetic tuples based on the plurality of tentative pairs corresponding to the matching pair, wherein each tuple of the set of synthetic tuples comprises of images of a tentative pair and a set of non-matching images with the tentative pair;
selecting a subset of k tuples from the set of synthetic tuples, wherein:
the subset of k tuples is selected randomly, or
the subset of k tuples is selected based on a geometric consistency score, wherein the synthetic tuple with lower geometric consistency score has higher probability of selection; and
computing the contrastive loss function on the subset of k pairs to update model parameters.

16. The system of claim 11, wherein the image retrieval model is trained using an AdamW optimizer for longer time with a cosine learning rate schedule.

17. The system of claim 11, wherein the weights are proportional to the degree of geometric correspondence inside the area of interest between images of the matching pair or a valid pair.

18. A computer-program product tangibly embodied in a non-transitory machine-readable storage medium, including instructions configured to cause one or more data processors to perform actions including:
accessing an initial dataset of real images of an environment, wherein for an image of the initial dataset there exists at least one matching image in the initial dataset and a set of non-matching images, the matching image represents similar scene of the environment as in the image of the initial dataset;
identifying a plurality of domain shifts, wherein each domain shift of the plurality of domain shifts corresponds to a potential change in the environment;
generating, for each image of the initial dataset and for each domain shift of the plurality of domain shifts, a synthetic image;
identifying a plurality of matching pairs in the initial dataset, wherein each matching pair of the plurality of matching pairs comprises of a first image and a second image and both images captures similar aspects or scene of the environment;
determining, for each matching pair of the plurality of matching pairs in the initial dataset, a plurality of tentative pairs, wherein each tentative pair of the plurality of tentative pairs includes at least one synthetic image, the tentative pairs are generated by making image pairs of:
the first image with the synthetic images of the second image, and
the synthetic images of the first image with the second image;
determining, for each tentative pair of the plurality of tentative pairs, geometric correspondences;
determining, for each tentative pair of the plurality of tentative pairs, whether the tentative pair is a valid pair or not based on a degree of the geometric correspondences between images of the tentative pair inside an area of interest;
generating an extended dataset by combining the initial dataset with the valid pairs; and
training an image retrieval model using a contrastive loss function with weights assigned to each matching pair and corresponding valid pairs in the extended dataset.

19. The computer-program product of claim 18, wherein the actions further include:
determining a geometric transformation between the first image and the second image of a matching pair of the initial dataset; and
computing, for each tentative pair of the plurality of tentative pairs corresponding to the matching pair, a number of local geometric correspondences that satisfy the geometric transformation, wherein the tentative pair is valid if an absolute or relative number of local geometric correspondences inside the area of interest exceeds a threshold.

20. The computer-program product of claim 18, wherein the actions further include:
generating a set of synthetic tuples based on the plurality of tentative pairs corresponding to the matching pair, wherein each tuple of the set of synthetic tuples comprises of images of a tentative pair and a set of non-matching images with the tentative pair;
selecting a subset of k tuples from the set of synthetic tuples, wherein:
the subset of k tuples is selected randomly, or
the subset of k tuples is selected based on a geometric consistency score, wherein the synthetic tuple with lower geometric consistency score has higher probability of selection; and
computing the contrastive loss function on the subset of k pairs to update model parameters.

21. The computer-program product of claim 18, wherein the image retrieval model is trained using an AdamW optimizer for longer time with a cosine learning rate schedule.
